(19) United States
(12) Patent Application Publication
(10) Pub. No.: US 2006/0282600 A1
(43) Pub. Date: Dec. 14, 2006

(54) Circuit for identifying CPU front side bus

(75) Inventor: Zhi-Hong Wang, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/435,069

(22) Filed: May 16, 2006

(30) Foreign Application Priority Data
May 28, 2005 (CN) 200510034952.6

(51) Int. Cl. G06F 13/36

(52) U.S. Cl. 710/306

(57) ABSTRACT

A circuit for identifying a CPU Front Side Bus (FSB) is provided. In one preferred embodiment, the circuit includes a CPU, a north bridge, and a control circuit. The CPU has a plurality of Bus Speed Select (BSEL) ends for transmitting FSB BSEL signals. The north bridge also has a plurality of BSEL ends for receiving the FSB BSEL signals sent from the CPU. The control unit connects the CPU and the north bridge. When the CPU FSB exceeds an identifying range of the north bridge, the control circuit converts the FSB BSEL signals to signals which the north bridge can identify. The circuit can identify a higher FSB of the CPU by using the north bridge that usually only supports lower FSB frequencies.

### BACKGROUND OF THE INVENTION

1. Field of the Invention

The present invention relates to computer systems, and more particularly to a circuit for identifying a central processing unit (CPU) front side bus.

2. Background

Front side bus (FSB) is a term describing a processor-to-system memory data bus. An FSB is also known as a local bus, memory bus, and system bus. The front side bus on a computer connects the processor to the north bridge. In general, a faster front side bus means higher processing speeds and a faster computer.

Intel's 915 and 925X chipsets support 533 MHz or 800 MHz FSB, but not for higher FSB frequencies such as 1066 MHz FSB.

Referring to FIG. 2, a conventional circuit for supporting 533 MHz/800 MHz FSB frequencies is shown. The circuit comprises a CPU 10 and a north bridge 20. FSB Frequency Select Signals BSEL [2:0] are connected between the CPU 10 and the north bridge 20. FSB Frequency Select Signals BSEL [2:0] are used to select the FSB clock frequency. The following table defines the select signals BSEL[2:0] and the frequency associated with each combination. A Pentium 4 processor in the 775-land package currently only operates at a 533 MHz or 800 MHz FSB frequency.

BSEL [2:0] Frequency Table

| FSB frequency | BSEL 2 | BSEL 1 | BSEL 0 |
|---|---|---|---|
| 533 MHz | L | L | H |
| 800 MHz | L | H | L |
| 1066 MHz | L | L | L |

Unfortunately, if a 1066 MHz FSB CPU is selected for use in the system, the select signals of the BSEL [2:0] for a 1066 MHz FSB CPU, as shown in the last line of Table 1, would not be recognized by the north bridge 20, and the system could not be powered up.

What is needed, therefore, is an identifying circuit which is capable of using 533 MHz/800 MHz FSB north bridge to support a 1066 MHz FSB CPU.

### SUMMARY

A circuit for identifying a CPU Front Side Bus (FSB) is provided. In one preferred embodiment, the circuit includes a CPU, a north bridge, and a control circuit unit. The CPU has a plurality of Bus Speed Select (BSEL) ends for transmitting FSB BSEL signals. The north bridge also has a plurality of BSEL ends for receiving the FSB BSEL signals sent from the CPU. The control unit connects the CPU and the north bridge. When the CPU FSB exceeds an identifying range of the north bridge, the control circuit converts the FSB BSEL signals to signals which the north bridge can identify.

It is of advantage that the circuit identifies a higher frequency FSB CPU as a lower frequency FSB CPU to the North bridge that usually only supports lower FSB frequencies. Thereby allowing operation of a 1066 MHz FSB CPU at 800 MHz with a standard 533 MHz/800 MHz FSB north bridge.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram showing a circuit for identifying a central processing unit (CPU) front side bus frequency in accordance with a preferred embodiment of the present invention; and

FIG. 2 is a circuit diagram showing a conventional circuit for supporting 533 MHz/800 MHz FSB CPUs.

### DETAILED DESCRIPTION OF THE EMBODIMENTS

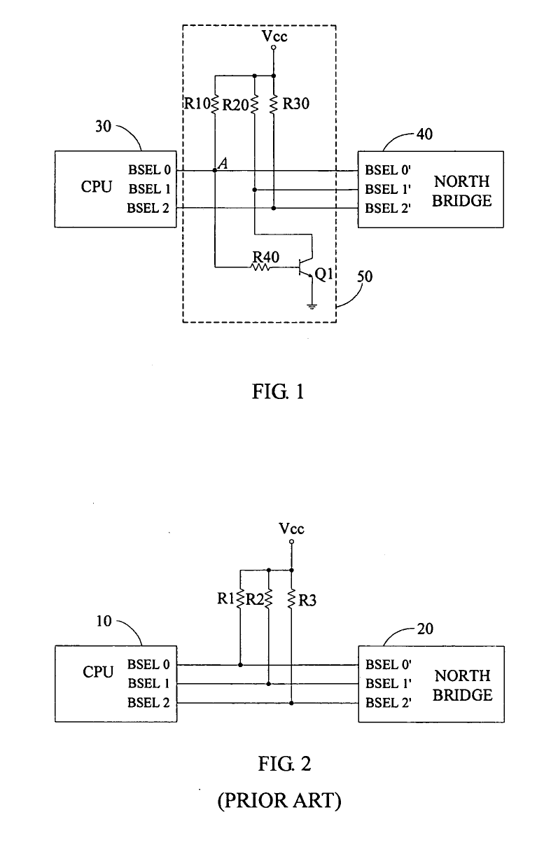

Referring to FIG. 1, a circuit for identifying a central processing unit (CPU) front side bus in accordance with a preferred embodiment of the present invention is shown. The circuit comprises a CPU 30 which can be any one of a 533 MHz, 800 MHz, or 1066 MHz FSB CPU type, a north bridge 40, and a control circuit unit 50. The north bridge 40 is the type that usually only supports FSB frequencies of the CPU 30 of 533 MHz/800 MHz.

The CPU 30 comprises a first bus speed select end BSEL 0, a second bus speed select end BSEL 1, and a third bus speed select end BSEL 2. BSEL 0 and BSEL 2 are coupled to a power supply end Vcc via resistors R10 and R30 respectively. The voltage of the power supply end Vcc is 1.2V.

The north bridge 40 also comprises a first bus speed select end BSEL 0′, a second bus speed select end BSEL 1′, and a third bus speed select end BSEL 2′. BSEL 0′ is connected to a node A between the BSEL 0 of the CPU 30 and the resistor RIO, BSEL 2′ is connected to a node between the BSEL 2 of the CPU 30 and the resistor R30. The control unit 50 comprises a resistor R40 and a transistor Q1. The resistor R40 is connected between the node A and a base of the transistor Q1, an emitter of the transistor Q1 is grounded. A collector of the transistor Q1 is coupled to a node between the second bus speed select end BSEL 1 of the north bridge 40 and a resistor R20, the resistor R20 is also connected to the power supply end Vcc.

When the CPU FSB is 1066 MHz, the select signal of the BSEL 0 of the CPU 30 is low, and the select signal received at the BSEL 0′ of the north bridge 40 is low; the transistor Q1 is turned off due to the low signal at the BSEL 0 of the CPU 30, and a high select signal is output at the collector of the transistor Q1. A select signal received at the BSEL 1′ of the north bridge 40 is high. The select signal of the BSEL 2 of the CPU 30 is low, the select signal received at the BSEL 2′ of the north bridge 40 is low. So the 1066 MHz FSB CPU is recognised as an 800 MHZ FSB CPU by the north bridge 40 and is operated at the 800 MHz frequency.

When the CPU FSB is 800 MHz, the select signal of the BSEL 0 of the CPU 30 is low, the select signal received at the BSEL 0′ of the north bridge 40 is low; the transistor Q1 is turned off due to the low signal at the BSEL 0 of the CPU 30, a high signal is output at the collector of the transistor Q1. A select signal received at the BSEL 1′ of the north bridge 40 is high. The select signal of the third bus speed select end BSEL 2 of the CPU 30 is low, the select signal received at the third bus speed select end BSEL 2′ of the north bridge 40 is low. So the 800 MHz FSB CPU is recognised as such by the north bridge 40.

When the CPU FSB is 533 MHz, the select signal of the BSEL 0 of the CPU 30 is high, the select signal received at the BSEL 0′ of the north bridge 40 is high; the transistor Q1 is turned on due to the high signal at the BSEL 0 of the CPU 30, a low signal is output at the collector of the transistor Q1. A select signal received at the BSEL 0′ of the north bridge 40 is low; the select signal of the BSEL 2 of the CPU 30 is low, the select signal received at the BSEL 2′ of the north bridge 40 is low. So the 533 MHz FSB CPU is recognized as such by the north bridge 40.

The following table defines the select signals of the BSEL [2:0] and the frequency associated with each combination.

| | BSEL signals | | | BSEL signals received | | |
|---|---|---|---|---|---|---|
| | sent from CPU | | | at north bridge | | |
| | BSEL | BSEL | BSEL | BSEL | BSEL | BSEL |
| CPU type | 2 | 1 | 0 | 2′ | 1′ | 0′ |
| 533 MHz | L | — | H | L | L | H |
| 800 MHz | L | — | L | L | H | L |
| 1066 MHz | L | — | L | L | H | L |

In the above-described identifying circuit of the preferred embodiment of the present invention, the 1066 MHz FSB CPU is recognised as an 800 MHZ FSB CPU by the north bridge and is operated at that frequency. The circuit can identify a higher FSB of the CPU so that the north bridge that usually only supports a lower frequency FSB will then also support a higher frequency FSB.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A circuit for identifying CPU Front Side Bus (FSB) comprising:
a central processing unit (CPU) having a plurality of Bus Speed Select (BSEL) ends for transmitting FSB BSEL signals;
a north bridge having a plurality of BSEL ends for receiving FSB BSEL signals sent from the CPU; and
a control circuit connected to the CPU and the north bridge, when the CPU FSB exceeds an identifying range of the north bridge, the control circuit converting the FSB BSEL signals sent from the CPU to signals which the north Bridge can identify.

2. The circuit as claimed in claim 1, wherein the CPU comprises a first bus speed select end connected to a power supply end via a first resistor, a second bus speed select end, and a third bus speed select end connected to the power supply end via a second resistor.

3. The circuit as claimed in claim 2, wherein the north bridge comprises a fist bus speed select end connected to a node between the first bus speed select end of the CPU and the first resistor, a second bus speed select end, and a third bus speed select end connected to a node between the third bus speed select end of the CPU and the second resistor.

4. The circuit as claimed in claim 3, wherein the control circuit comprises a third resistor and a transistor, one end of the third resistor is connected to the node between the firs bus speed select end of the CPU and the first resistor, the other end of the third resistor is connected to a base of the transistor, an emitter of the transistor is grounded, a collector of the transistor is coupled to a node between the second bus speed select end of the CPU and the a fourth resistor, the fourth resistor is coupled to the power supply end.

5. The circuit as claimed in claim 4, wherein the CPU has a 1066 MHz FSB frequency and operates at 800 MHz.

6. A circuit for identifying CPU Front Side Bus (FSB) comprising:
a central processing unit (CPU) having a first Bus Speed Select (BSEL) end, a second bus speed select end, and a third bus speed select end;
a north bridge having a first bus speed select end connected to the first bus speed select end of the CPU, a second bus speed end, and a third bus speed end connected to the third bus speed end of the CPU; and
a control circuit comprising a transistor and a first resistor connected between the first bus speed select end of the CPU and a base of the transistor, an emitter of the transistor being grounded, and a collector of the transistor connected to the second bus speed select end of the north bridge.

7. The circuit as claimed in claim 6, wherein the first and third bus speed select ends of the CPU are connected to a power supply end via a second resistor and a third resistor respectively.

8. The circuit as claimed in claim 6, wherein the collector of the transistor is coupled to a node between a fourth resistor and the second bus speed select end of the north bridge.

9. The circuit as claimed in claim 6, wherein the CPU has a 1066 MHz FSB frequency and operates at 800 MHz.

10. A circuit assembly comprising:
a central processing unit (CPU) comprising signal-transmitting ends to provide an set of signals to identify a current speed of said CPU selectively out of a group of a first type of speed for said CPU and a second type of speed for said CPU;
a north bridge comprising signal-receiving ends to accept said set of signals from said CPU in order to recognize said current speed of said CPU and enable said CPU to work, said north bridge configured to recognize said first type of speed for said CPU and unable to recognize said second type of speed for said CPU; and
a control circuit electrically connectable between said signal-transmitting ends of said CPU and said signal-receiving ends of said north bridge in order to transmit said set of signals from said CPU to said north bridge, said control circuit accepting said set of signals recognizable as a selective one of said first and second types of speed for said CPU and transmitting said set of signals to said north bridge by transforming said set of signals to another set of signals recognizable by said north bridge only as said first type of speed for said CPU in order to enable said CPU to work regardless of acceptance of said selective one of said first and second types of speed for said CPU.

11. The circuit assembly as claimed in claim 10, wherein said set of signals comprises a first Bus Speed Select (BSEL) signal, a second BSEL signal and a third BSEL signal, said control circuit retrieves two of said first, second and third BSEL signals from said CPU and transmits all of said first, second and third BSEL signals as said another set of signals to said north bridge.

12. The circuit assembly as claimed in claim 10, wherein said control circuit comprises a transistor responsive to one signal from said set of signals in order to generate another signal of said set of signals.

13. The circuit assembly as claimed in claim 10, wherein said first type of speed for said CPU comprises 533 MHz and 800 MHz, and said second type of speed for said CPU comprises 1066 MHz.
